(19) United States
(12) Patent Application Publication
(10) Pub. No.: US 2022/0412020 A1
(43) Pub. Date: Dec. 29, 2022

(54) METHOD AND SYSTEM FOR CONTROLLING GROUND CUTTING IMPLEMENT OF MACHINES

(71) Applicant: Caterpillar Paving Products Inc., Brooklyn Park, MN (US)

(72) Inventors: Matthew-David S. Frantz, Eden Prairie, MN (US); Derek Nieuwsma, Loretto, MN (US); Ryan Enot, Dunlap, IL (US); Nathaniel S. Doy, Maple Grove, MN (US)

(73) Assignee: Caterpillar Paving Products Inc., Brooklyn Park, MN (US)

(21) Appl. No.: 17/304,954

(22) Filed: Jun. 29, 2021

(51) Int. Cl. E01C 23/088

(52) U.S. Cl. CPC E01C 23/088

(57) ABSTRACT

A method for controlling a ground cutting implement includes receiving, by a first controller, an input to actuate the ground cutting implement and determining, by the first controller, primary parameters associated with an activation of a fluid regulation valve. The method includes receiving, by the first controller, data corresponding to secondary parameters associated with an activation of a flow control valve from the second controller. Further, the method includes activating, by the first controller, the fluid regulation valve and communicating a first instruction to the second controller to activate the flow control valve if each of the primary and the secondary parameters meet corresponding parameter threshold conditions. The method also includes deactivating, by the first controller, the fluid regulation valve and communicating a second instruction to the second controller to deactivate the flow control valve if any of the primary or the secondary parameters violate any corresponding parameter threshold conditions.

### TECHNICAL FIELD

The present disclosure relates to a control of ground cutting implements, such as milling drums of milling machines. More particularly, the present disclosure relates to a method and system that prevents an un-commanded actuation of a ground cutting implement.

### BACKGROUND

Machines, such as milling machines, cold planers, rotary mixers, etc., may be used for activities, such as rehabilitating or reclaiming deformed and/or aged roadways so that the roadways can be reformed and reused for transportation. Such machines generally include a ground cutting implement, such as a milling drum with cutting tools disposed around the surface of the milling drum. During operations, the ground cutting implement may be lowered to engage the surface of the roadway and may then be driven (e.g., rotated) so as to engage, break up, and pulverize the surface. Once the surface is pulverized, the resulting disintegrated particles may be conveyed away into a container.

Various systems and parts of such a machine, such as the ground cutting implement and/or the cutting tools of the ground cutting implement, may need regular servicing and maintenance. In certain cases, the operator may also need to keep the machine's engine running while the maintenance activity is performed—this is because the operator may require one or more tools powered by the engine to perform the maintenance activity.

U.S. Pat. No. 4,929,121 relates to a control system for a rotary cutter in which mechanical drive components are selectively and sequentially controlled in response to operator inputs and to sensed operating conditions. The control responds to the occurrence of predefined fault events and internal system failures by controlling the operation of one or more mechanical drive line components in a preselected order. Furthermore, suitable time delays are provided between the execution of selected commands to prevent undesirable wear or loads on components of the drive train.

### SUMMARY OF THE INVENTION

In one aspect, the disclosure is directed to a method for controlling a ground cutting implement of a machine. The method includes receiving, by one of a first controller or a second controller, an input to actuate the ground cutting implement and determining, by one of the first controller or the second controller, one or more primary parameters associated with an activation of a fluid regulation valve in response to the input. The fluid regulation valve is configured to be activated to regulate a fluid pressure to actuate the ground cutting implement and be deactivated to inhibit the fluid pressure to stop the ground cutting implement. The method includes receiving, by one of the first controller or the second controller, data corresponding to one or more secondary parameters associated with an activation of a flow control valve from the other of the first controller or the second controller. The flow control valve is configured to be activated to allow passage of a fluid flow and be deactivated to disallow passage of the fluid flow. Further, the method includes activating, by one of the first controller or the second controller, the fluid regulation valve and communicating a first instruction to the other of the first controller or the second controller to activate the flow control valve if each of the primary parameters and the secondary parameters meet corresponding parameter threshold conditions. The method also includes deactivating, by one of the first controller or the second controller, the fluid regulation valve and communicating a second instruction to the other of the first controller or the second controller to deactivate the flow control valve if any of the primary parameters or the secondary parameters violate any corresponding parameter threshold conditions.

In another aspect, the disclosure relates to a machine. The machine includes a ground cutting implement, a fluid regulation valve, a flow control valve, a first controller, and a second controller. The fluid regulation valve is configured to be activated to regulate a fluid pressure to actuate the ground cutting implement and be deactivated to inhibit the fluid pressure to stop the ground cutting implement. The flow control valve is configured to be activated to allow passage of a fluid flow and be deactivated to disallow passage of the fluid flow. One of the first controller or the second controller configured to receive an input to actuate the ground cutting implement; determine one or more primary parameters associated with an activation of the fluid regulation valve in response to the input; receive data corresponding to one or more secondary parameters associated with an activation of the flow control valve from the other of the first controller or the second controller; activate the fluid regulation valve and communicate a first instruction to the other of the first controller or the second controller to activate the flow control valve if each of the primary parameters and the secondary parameters meet corresponding parameter threshold conditions; and deactivate the fluid regulation valve and communicate a second instruction to the other of the first controller or the second controller to deactivate the flow control valve if any of the primary parameters or the secondary parameters violate any corresponding parameter threshold conditions.

In yet another aspect, the disclosure is directed to a system for controlling a ground cutting implement of a machine. The system includes a fluid regulation valve, a flow control valve, a first controller and a second controller. The fluid regulation valve is configured to be activated to regulate a fluid pressure to actuate the ground cutting implement and be deactivated to inhibit the fluid pressure to stop the ground cutting implement. The flow control valve is configured to be activated to allow passage of a fluid flow and be deactivated to disallow passage of the fluid flow. One of the first controller or the second controller is configured to receive an input to actuate the ground cutting implement; determine one or more primary parameters associated with an activation of the fluid regulation valve in response to the input; receive data corresponding to one or more secondary parameters associated with an activation of the flow control valve from the other of the first controller or the second controller; activate the fluid regulation valve and communicate a first instruction to the other of the first controller or the second controller to activate the flow control valve if each of the primary parameters and the secondary parameters meet corresponding parameter threshold conditions; and deactivate the fluid regulation valve and communicate a second instruction to the other of the first controller or the second controller to deactivate the flow control valve if any of the primary parameters or the secondary parameters violates any corresponding parameter threshold conditions.

### BRIEF DESCRIPTION OF THE DRAWINGS

FIG. 1 is a side view of an exemplary machine having a ground cutting implement assembly, in accordance with one or more aspects of the present disclosure;

FIG. 2 is a schematic view of an exemplary system for controlling the ground cutting implement of the machine, in accordance with one or more aspects of the present disclosure; and

FIG. 3 is a flowchart illustrating a method for controlling the ground cutting implement, in accordance with one or more aspects of the present disclosure.

### DETAILED DESCRIPTION

Reference will now be made in detail to specific embodiments or features, examples of which are illustrated in the accompanying drawings. Generally, corresponding reference numbers may be used throughout the drawings to refer to the same or corresponding parts.

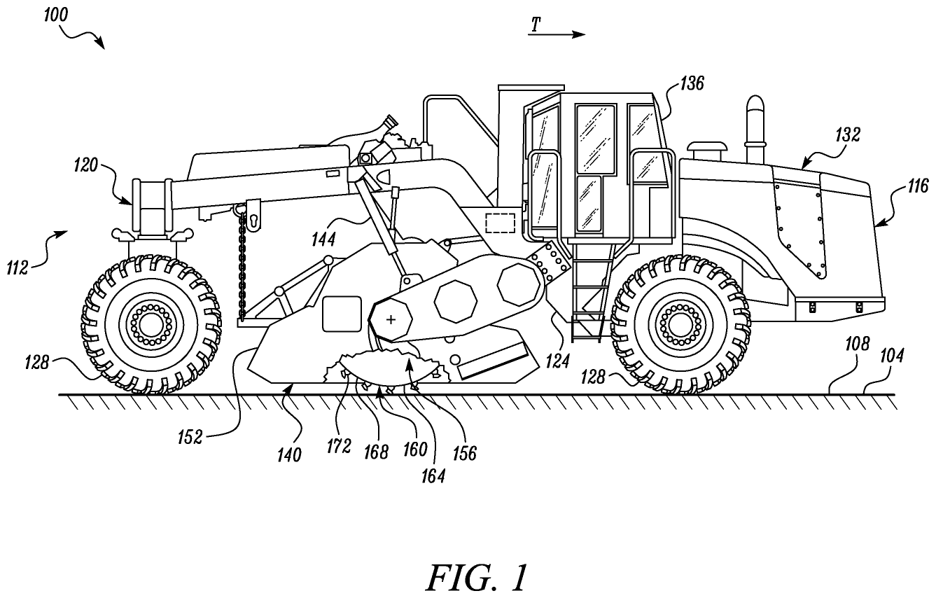

Referring to FIG. 1, a machine 100 is illustrated. The machine 100 may be used to cut, mix, and pulverize a ground surface 104 of a roadway 108 for various purposes such as to reclaim the roadway 108. The machine 100 may include a rotary mixer machine 112, as shown. The machine 100 may include a forward end 116 and a rearward end 120. The rearward end 120 and the forward end 116 may be opposite to each other. The forward end 116 and the rearward end 120 may be defined in relation to an exemplary direction of travel, T, of the machine 100, with said direction of travel being defined from the rearward end 120 towards the forward end 116. As the machine 100 may move along the direction, T, the ground surface 104 may be cut and pulverized. Once the ground surface 104 is pulverized, resulting disintegrated particles may be conveyed away into a container (not shown). Although the machine 100 is disclosed, one or more aspects of the present disclosure may be applicable to other types of construction machines and work machines, e.g., cold planers.

Among many parts and subsystems of the machine 100, the machine 100 includes a frame 124, one or more traction devices 128 to support the frame 124 over the ground surface 104, a propulsion system 132 to propel the machine 100, an operator cabin 136 to control various functions of the machine 100, and a ground cutting implement assembly 140. The frame 124 may extend between the forward end 116 and the rearward end 120 of the machine 100. Although not limited, the frame 124 may be implemented in and/or assembled from multiple parts and components, and, in some cases, may define a spilt-frame configuration. The frame 124 may accommodate or support each of the propulsion system 132, the operator cabin 136, the ground cutting implement assembly 140, and also, one or more actuators 144 that may be applied to tilt and/or pan the ground cutting implement assembly 140 with respect to the ground surface 104.

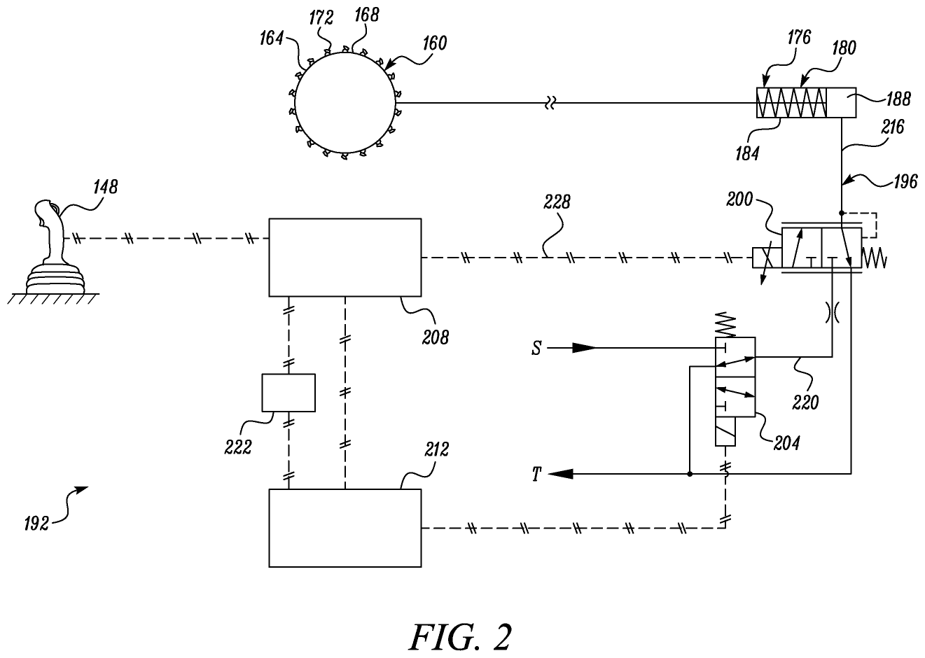

The operator cabin 136 may be supported over the frame 124. The operator cabin 136 may facilitate stationing of one or more operators therein. Also, the operator cabin 136 may house various components and controls of the machine 100, accessing one or more of which may help the operators control the machine's movement and/or operation. For example, the operator cabin 136 may include an input device 148 (see FIG. 2) that may be used and/or actuated by an operator to generate an input for facilitating control and operation of one or more functions of the ground cutting implement assembly 140. The input device 148 may include, but is not limited to, one or more of touch screens, joysticks, switches, and the like. In some embodiments, the machine 100 may be operated autonomously or semi-autonomously. In such a case, the operator cabin 136 and/or the input device 148 may be omitted from the machine 100 and they may be located remotely to the machine 100 or to the site of machine operations.

Referring to FIGS. 1 and 2, the ground cutting implement assembly 140 may include a mixing chamber 152. The mixing chamber 152 may be formed by combining several panels or plates together and may define an enclosure 156. The ground cutting implement assembly 140 may also include a ground cutting implement 160, e.g., a milling rotor 164, that may be housed within the enclosure 156. The ground cutting implement 160 may include a drum 168 and multiple cutting tools 172 may be arranged around the drum 168. The ground cutting implement 160 may be powered and spun and be brought into contact with the ground surface 104 to break-up and pulverize one or more layers of materials from the ground surface 104.

To power the ground cutting implement 160, the ground cutting implement assembly 140 may include a drive system 176 that may deliver power from the propulsion system 132 to the ground cutting implement 160 to power and spin the ground cutting implement 160. During operation, as the machine 100 may advance along the ground surface 104, i.e., over the roadway 108 that is to be reclaimed, the ground cutting implement 160 may be spun by way of the drive system 176 and lowered towards the ground surface 104, and, in process, the rotating cutting tools 172 of the ground cutting implement 160 may penetrate into the ground surface 104 and may break-up and lift the one or more layers of material from the ground surface 104, causing the layers to disintegrate and be collected within the mixing chamber 152.

The drive system 176 may include a clutch 180 that may be fluidly operated to either disengage the ground cutting implement 160 from the propulsion system 132 or engage the ground cutting implement 160 to the propulsion system 132. To this end, the clutch 180 may include an actuator portion 184 defining a chamber 188. As an example, the chamber 188 may receive fluid to enable the clutch 180 to engage the propulsion system 132 to the ground cutting implement 160 (i.e., an engaged state of the clutch 180) and may release fluid to disengage the propulsion system 132 from the ground cutting implement 160 (i.e., a disengaged state of the clutch 180). When the clutch 180 is in the engaged state, power may be received and transferred from the propulsion system 132 to the ground cutting implement 160 to run or spin the ground cutting implement 160. When the clutch 180 is in the disengaged state, receipt of power from the propulsion system 132 may be halted to depower and stop the running or spinning of the ground cutting implement 160.

The forthcoming description includes details related to a system 192 for controlling the ground cutting implement 160. The system 192 may work in conjunction with the clutch 180. According to one or more aspects of the present disclosure, the system 192 prevents an un-commanded actuation of the clutch 180 and/or the ground cutting implement 160. The system 192 includes a fluid circuit 196 with a fluid supply indicated at, S, and a fluid reservoir indicated at, T Further, the system 192 includes a fluid regulation valve 200, a flow control valve 204, a first controller 208, and a second controller 212.

The fluid regulation valve 200 may be fluidly coupled to the chamber 188 of the actuator portion 184 of the clutch 180 via a first fluid line 216 of the fluid circuit 196. The fluid regulation valve 200 may be configured to be activated to regulate a fluid pressure to deliver fluid to the chamber 188 and actuate (i.e., start the running or spinning of) the ground cutting implement 160 and be deactivated to inhibit the fluid pressure to the chamber 188 and stop (i.e., stop the running or spinning of) the ground cutting implement 160. The fluid regulation valve 200 may be a proportional pressure reducing valve. In other embodiments, the fluid regulation valve 200 may be a proportional flow control valve or an on/off valve or other types of valves that may regulate a pressure and/or flow. In some embodiments, the regulation of fluid as facilitated by the fluid regulation valve 200 may mean that an amount of fluid passed through the fluid regulation valve 200 may be in proportion to the power or current supplied to the fluid regulation valve 200 to activate the fluid regulation valve 200. In some implementations, as a power or current supplied to the fluid regulation valve 200 may be increased, the fluid regulation valve 200 may be regulated to proportionally increase the fluid pressure to the chamber 188; and, in some implementations, as the power or current supplied to the fluid regulation valve 200 may be decreased, the fluid regulation valve 200 may be regulated to proportionally decrease the fluid pressure to the chamber 188.

The flow control valve 204 may be fluidly coupled to the fluid regulation valve 200 via a second fluid line 220 of the fluid circuit 196. The flow control valve 204 may be configured to be activated to allow passage of a fluid flow towards the fluid regulation valve 200 and be deactivated to disallow passage of the fluid flow towards the fluid regulation valve 200. To this end, the flow control valve 204 may be fluidly coupled in series with the fluid regulation valve 200 and may be positioned upstream to the fluid regulation valve 200 with respect to the fluid flow when the direction of the fluid flow is towards the chamber 188 of the actuator portion 184 to actuate the ground cutting implement 160 and bring the propulsion system 132 in engagement with the ground cutting implement 160. In some embodiments, it is possible for the flow control valve 204 to be positioned downstream of the fluid regulation valve 200, as well.

The first controller 208 may be communicably coupled to each of the input device 148, the fluid regulation valve 200, and the second controller 212, as shown. The first controller 208 may be configured to receive an input from the input device 148—e.g., to actuate the ground cutting implement 160. Pursuant to the receipt of the input or in response to the input, the first controller 208 may be configured to run a set of instructions (e.g., a first set of instruction) and may be configured to issue a first command for the activation of the fluid regulation valve 200 and facilitate supply of a current (e.g., a first current) to the fluid regulation valve 200 to activate the fluid regulation valve 200 in response to an issuance of the first command. Simultaneously, or subsequent to the receipt of the input by the first controller 208, the first controller 208 may also pass the input, received from the input device 148, to the second controller 212.

The second controller 212 may be similar (e.g., in its specification) to the first controller 208 and may be communicably coupled to the flow control valve 204 and to the first controller 208. In response to the input or pursuant to the receipt of the input from the first controller 208, the second controller 212 may be configured to run a set of instructions (e.g., a second set of instruction) and may be configured to issue a second command for the activation of the flow control valve 204 and facilitate supply of a current (e.g., a second current) to the flow control valve 204 to activate the flow control valve 204 in response to an issuance of the second command. In that manner, both the fluid regulation valve 200 and the flow control valve 204 may be activated for the actuation of the ground cutting implement 160 of the machine 100.

In response to the input, and simultaneously or in sequence to the issuance of the first command, the first controller 208 may also start determining one or more primary parameters associated with an activation of the fluid regulation valve 200. In some examples, the primary parameters may include one or more primary current parameters. The primary current parameters may include the current (e.g., first current) supplied to the fluid regulation valve 200 to activate the fluid regulation valve 200 in response to the issuance of the first command.

Once the primary parameters are determined, the first controller 208 may retrieve corresponding parameter threshold conditions (or corresponding primary parameter threshold conditions) and may compare each of the primary parameters with their corresponding primary parameter threshold conditions. For example, the primary current parameters may be compared against corresponding current thresholds. The first controller 208 may formulate the results of the comparison (i.e., indicating whether the primary parameters meet or violate the corresponding primary parameter threshold conditions or not) as first data.

As the first controller 208 may communicate or deliver the input to the second controller 212 and as the second controller 212 may issue the second command pursuant to the receipt of the input, simultaneously, or in sequence to the issuance of the second command, the second controller 212 may also start determining one or more secondary parameters associated with an activation of the flow control valve 204. In some examples, the secondary current parameters may include the current (e.g., second current) supplied to the flow control valve 204 to activate the flow control valve 204 in response to the issuance of the second command.

Once the secondary parameters are determined, the second controller 212 may retrieve corresponding parameter threshold conditions (or corresponding secondary parameter threshold conditions) and may compare each of the secondary parameters with their corresponding secondary parameter threshold conditions. For example, the secondary current parameters may be compared against corresponding current thresholds. The second controller 212 may formulate the results of the comparison (i.e., indicating whether the secondary parameters meet or violate the corresponding secondary parameter threshold conditions or not) as second data. In that manner, the second controller 212 determines data (i.e., second data) corresponding to the secondary parameters associated with the activation of the flow control valve 204. Further, in some embodiments, the second controller 212 is also configured to deliver the second data to the first controller 208, or, in other words, the first controller 208 is configured to receive said second data from the second controller 212.

According to one aspect of the present disclosure, one or more of the first controller 208 and/or the second controller 212 may also be configured to determine one or more additional parameters associated with a communication between the first controller 208 and the second controller 212. In some examples, the communication may include or relate to one or more of a receipt of the input by the second controller 212 from the first controller 208 (i.e., passing of the input by the first controller 208 to the second controller 212) and/or the receipt of second data by the first controller 208 from the second controller 212. The additional parameters associated with the communication may include one or more of a voltage or a current associated with electrical signals that may be transmitted between the first controller 208 and the second controller 212 during the communication. Further, one or more of the first controller 208 or the second controller 212 may compare the additional parameters with their corresponding additional parameter threshold conditions and may formulate the results of the comparison (i.e., indicating whether the additional parameters meet or violate the corresponding additional parameter threshold conditions or not) as additional data.

If the first controller 208 detects that each of the primary parameters meet the corresponding primary parameter threshold conditions (i.e., first data) and if the second controller 212 detects that each of the secondary parameters meet the corresponding secondary parameter threshold conditions (i.e., second data corresponding to the secondary parameters which may be also received by the first controller 208), the first controller 208 may proceed to activate the fluid regulation valve 200 and may communicate a first instruction to the second controller 212 to also activate the flow control valve 204. Additionally, or optionally, one or more of the first controller 208 or the second controller 212 may also determine that the additional parameters meet the corresponding additional parameter threshold conditions (i.e., additional data), as well, before activating the fluid regulation valve 200 and the flow control valve 204.

However, if the first controller 208 detects any of the primary parameters to violate any corresponding primary parameter threshold conditions (i.e., first data) or if the second controller 212 detects any of the secondary parameters to violate any corresponding secondary parameter threshold conditions (i.e., second data corresponding to the secondary parameters which may be also received by the first controller 208), the first controller 208 may proceed to deactivate the fluid regulation valve 200 and may communicate a second instruction to the second controller 212 to deactivate the flow control valve 204, as well. It may be noted that a configuration of the fluid regulation valve 200 and the flow control valve 204, as shown in FIG. 1, correspond to their exemplary deactivated states.

Additionally, or optionally, one or more of the first controller 208 or the second controller 212 may also determine that the additional parameters violate the corresponding additional parameter threshold conditions for deactivating the fluid regulation valve 200 and the flow control valve 204. In other words, if any of the primary parameters, secondary parameters, or the additional parameters violate their corresponding parameter threshold conditions, the first controller 208 may proceed to deactivate the fluid regulation valve 200 and may communicate the second instruction to the second controller 212 to deactivate the flow control valve 204, as well.

Both the first controller 208 and the second controller 212 may be communicably coupled to the memory 222 within which threshold conditions corresponding to each of the aforementioned parameters may be stored. Therefore, once the parameters are determined, the first controller 208 and the second controller 212 may retrieve said threshold conditions from the memory 222 and may compare the parameters with the threshold conditions to determine whether the parameters meet the threshold conditions or violate the threshold conditions, and accordingly prepare or formulate the first data and second data. In some embodiments, the memory 222 may also store the first set of instruction and the second set of instruction and/or additional sets of instructions for one or more other functions of the machine 100.

Further, the first controller 208 may be also configured to receive a signal to stop the ground cutting implement 160. Although not limited, the signal could be delivered to the first controller 208 via the input device 148, itself. In response to the signal, the first controller 208 may be configured to deactivate the fluid regulation valve 200 and communicate the second instruction to the second controller 212 to deactivate the flow control valve 204, as well. In that manner, fluid flow is inhibited to flow into the chamber 188, thereby moving the clutch 180 to a disengaged state and stopping the ground cutting implement 160.

One or more of the functions of the first controller 208 and the second controller 212 may be performed by the other of the first controller 208 or the second controller 212. Therefore, the functionality of the first controller 208 and the second controller 212, as discussed above, may be seen as one exemplary implementation of the aspects of the present disclosure. Further, both the first controller 208 and the second controller 212 may be connected to the machine's electronic control module (ECM) (not shown), such as a safety module or a dynamics module, or may be configured as a stand-alone entities. Optionally, the first controller 208 may be integral and be one and the same as one ECM of the machine 100 and the second controller 212 may be integral and be one and the same as another ECM of the machine 100.

Both the first controller 208 and the second controller 212 may be a microprocessor-based device, and/or may be envisioned as application-specific integrated circuits, or other logic devices, which provide controller functionality, and such devices being known to those with ordinary skill in the art. In one example, it is possible for the first controller 208 and the second controller 212 to include or be representative of one or more controllers having separate or integrally configured processing units to process a variety of data (or input). In some embodiments, the first controller 208 and the second controller 212 may be part of one and the same controlling entity.

Further, both the first controller 208 and the second controller 212 may be optimally suited for accommodation within certain machine panels or portions from where they may remain accessible for ease of use, service, calibration, and repairs. Both the first controller 208 and the second controller 212 may be hard-wired correspondingly to the fluid regulation valve 200 and the flow control valve, and to each other, and also optionally to various other components and devices of the machine (see, for example, wiring 228). Although not limited, a connection of one or more of the first controller 208 or the second controller 212 to the input device 148 may be hard wired, as well. In some embodiments or examples, a transmission of data between the first controller 208 and the second controller 212 may be facilitated through a standardized CAN bus.

Processing units of the first controller 208 and the second controller 212, to convert and/or process the input and/or signals from the input device 148 may include, but are not limited to, an X86 processor, a Reduced Instruction Set Computing (RISC) processor, an Application Specific Integrated Circuit (ASIC) processor, a Complex Instruction Set Computing (CISC) processor, an Advanced RISC Machine (ARM) processor, or any other processor.

Examples of the memory 222 may include a hard disk drive (HDD), and a secure digital (SD) card. Further, the memory 222 may include non-volatile/volatile memory units such as a random-access memory (RAM)/a read only memory (ROM), which include associated input and output buses. The memory 222 may be configured to store various other instruction sets for various other functions of the machine 100, along with the first set of instruction and the second set of instruction, discussed above.

### INDUSTRIAL APPLICABILITY

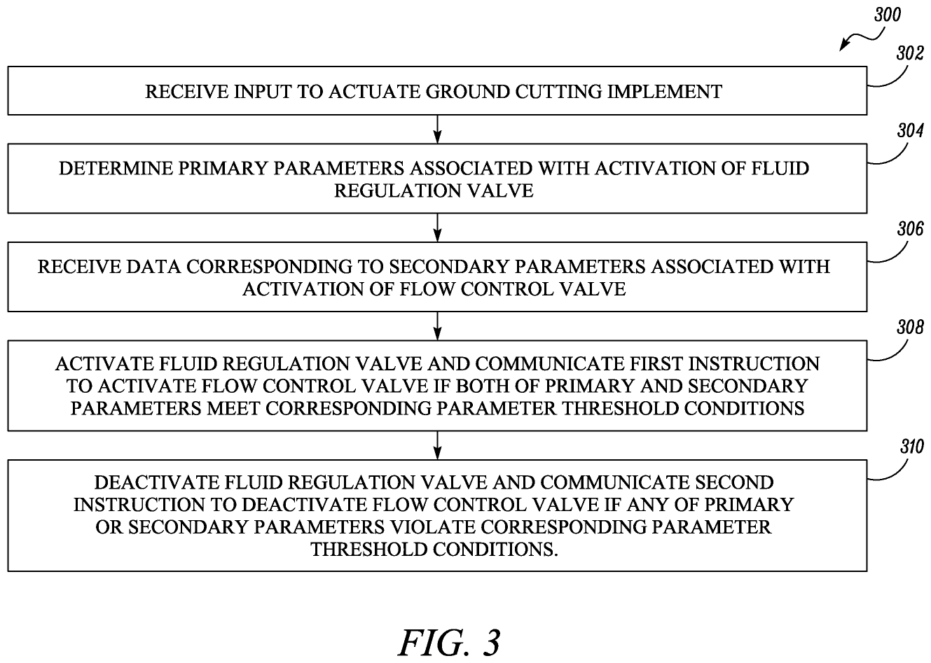

Referring to FIG. 3, an exemplary method for controlling the ground cutting implement 160 is set out further below. The method is discussed by way of a flowchart 300 and illustrates an exemplary process executable by the first controller 208 and the second controller 212 as they work in concert with each other. The flowchart 300 is discussed in conjunction with discussions that correspond to FIGS. 1 and 2. The method starts at step 302.

At step 302, for an activation of the ground cutting implement, the first controller 208 receives the input. The input may be generated by the input device 148 as an operator may access the input device 148 and may suitably manipulate it with the intention to actuate the ground cutting implement 160 (i.e., to power a running or a spinning of the ground cutting implement 160). Once the input is generated, the input device 148 delivers the input to the first controller 208, or, in other words, the first controller 208 receives the input from the input device 148. In response to the input or pursuant to the delivery of the input to the first controller 208, the first controller 208 may run the first set of instructions and may issue the first command for the activation of the fluid regulation valve 200. In response to the issuance of the first command, the first controller 208 may facilitate the supply of the current (e.g., the first current) to the fluid regulation valve 200 to activate the fluid regulation valve 200. The method proceeds to step 304.

At step 304, further in response to the input, the first controller 208 determines one or more of the primary parameters associated with the activation of the fluid regulation valve 200. For example, the first controller 208 may determine the current (e.g., first current) supplied to the fluid regulation valve 200 to activate the fluid regulation valve 200 in response to the issuance of the first command. At this step, the first controller 208 may also be configured to formulate the first data—i.e., data indicating whether the primary parameters meet or violate the corresponding primary parameter threshold conditions or not.

Simultaneously, or subsequent to the receipt of the input by the first controller 208, the first controller 208 may also pass the input to the second controller 212. In response to the input or pursuant to the receipt of the input by the second controller 212 from the first controller 208, the second controller 212 may be configured to run a set of instructions (e.g., the second set of instruction) and may be configured to issue a second command for the activation of the flow control valve 204 and facilitate supply of a current (e.g., a second current) to the flow control valve 204 to activate the flow control valve 204. In that manner, both the fluid regulation valve 200 and the flow control valve 204 may be activated for the actuation of the ground cutting implement 160.

Further, the second controller 212 determines one or more secondary parameters associated with an activation of the flow control valve 204. For example, the second controller 212 may determine the current (e.g., second current) supplied to the flow control valve 204 to activate the flow control valve 204 in response to the issuance of the second command. Thereafter, the second controller 212 may formulate the second data—i.e., data indicating whether the secondary parameters meet or violate the corresponding secondary parameter threshold conditions or not. The method proceeds to step 306.

At step 306, the first controller 208 receives the second data from the second controller 212. The method proceeds to step 308.

At step 308, the first controller 208 may activate the fluid regulation valve 200 (i.e., supply the first current to the fluid regulation valve 200) and may communicate the first instruction to the second controller 212 to also activate the flow control valve 204 if each of the primary parameters and the secondary parameters meet corresponding parameter threshold conditions. The method proceeds to step 310.

At step 310, the first controller 208 may deactivate the fluid regulation valve 200 (i.e., disable supply of the first current to the fluid regulation valve 200) and may communicate a second instruction to the second controller 212 to deactivate the flow control valve 204 (i.e., disable supply of the second current to the flow control valve 204) if any of the primary parameters or the secondary parameters violate any corresponding parameter threshold conditions. The method ends at step 310.

In some embodiments, before activating the fluid regulation valve 200 and the flow control valve 204, one or more of the first controller 208 or the second controller 212 may also determine that the additional parameters meet the corresponding additional parameter threshold conditions (i.e., additional data), as well. However, if any of the additional parameters violate the corresponding additional parameter threshold conditions, the first controller 208 may proceed to deactivate the fluid regulation valve 200 and may further communicate the second instruction to the second controller 212 to deactivate the flow control valve 204, as well.

In instances where any of the primary parameters, the secondary parameters, and the additional parameters, may violate the corresponding parameter threshold conditions, one or both of the first controller 208 and the second controller 212 may determine such instances as a ‘fault instances’ of the system 192. Conversely, in instances where the each of the primary parameters, the secondary parameters, and the additional parameters may meet corresponding parameter threshold conditions, one or both of the first controller 208 and the second controller 212 may determine such instances as a ‘no fault instances’ of the system 192. In addition to determining the ‘no fault instances’ of the system 192, the first controller 208 (or the second controller 212, or both), in some embodiments, may also determine that the propulsion system 132 is running (or is powered) and that the machine 100 is not in a service mode before activating the fluid regulation valve 200 and before communicating the first instruction to also have the flow control valve 204 activated.

Effectively, it may be noted that the first data, second data, and the additional data, may be indicative of a state of energy respectively between the fluid regulation valve 200 and the first controller 208, between the flow control valve 204 and the second controller 212, and between the first controller 208 and the second controller 212. Said data may also be indicative of the health of one or more the components (e.g., the fluid regulation valve 200, the flow control valve 204, the first controller 208, and the second controller 212) of the system 192.

For stopping the ground cutting implement 160, an operator may access and suitably manipulate the input device 148 to generate a signal. The first controller 208 may receive the signal and may deactivate the fluid regulation valve 200 and may communicate the second instruction to the second controller 212 to deactivate the flow control valve 204. In some embodiments, pursuant to the receipt of the second instruction by the second controller 212, the first controller 208 and the second controller 212 may both correspondingly deactivate the fluid regulation valve 200 and the flow control valve 204, simultaneously.

If any of the primary parameters or the secondary parameters violate any corresponding parameter threshold conditions, the system 192 effectively helps detect that at least one of the functions associated with the first controller 208, the second controller 212, the fluid regulation valve 200, the flow control valve 204, or the wirings therebetween (see, for example, wiring 228), is at fault or is malfunctioning, and, accordingly, the first controller 208 and the second controller 212 may respectively deactivate both the fluid regulation valve 200 and the flow control valve 204.

The system 192 and the corresponding method, as discussed above by way of the flowchart 300, includes the flow control valve 204 provided upstream to the fluid regulation valve 200 and the second controller 212 that assists in the functioning of the flow control valve 204. Both the flow control valve 204 and the second controller 212 function to serve as a redundant control mechanism ensuring the avoidance of an un-commanded actuation of the ground cutting implement 160 by helping depower and stop the ground cutting implement 160 the moment any malfunction or fault is detected. Such a system and method may be applicable in cases where the propulsion system 132 needs to be maintained in a running state while a maintenance activity is being performed on or around the machine 100.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

What is claimed is:

1. A method for controlling a ground cutting implement of a machine, the method comprising:
receiving, by one of a first controller or a second controller, an input to actuate the ground cutting implement;
determining, by one of the first controller or the second controller, one or more primary parameters associated with an activation of a fluid regulation valve in response to the input, the fluid regulation valve configured to be activated to regulate a fluid pressure to actuate the ground cutting implement and be deactivated to inhibit the fluid pressure to stop the ground cutting implement;
receiving, by one of the first controller or the second controller, data corresponding to one or more secondary parameters associated with an activation of a flow control valve from the other of the first controller or the second controller, the flow control valve configured to be activated to allow passage of a fluid flow and be deactivated to disallow passage of the fluid flow;
activating, by one of the first controller or the second controller, the fluid regulation valve and communicating a first instruction to the other of the first controller or the second controller to activate the flow control valve if each of the one or more primary parameters and the one or more secondary parameters meet corresponding parameter threshold conditions; and
deactivating, by one of the first controller or the second controller, the fluid regulation valve and communicating a second instruction to the other of the first controller or the second controller to deactivate the flow control valve if any of the one or more primary parameters or the one or more secondary parameters violate any corresponding parameter threshold conditions.

2. The method of claim 1 further comprising:
receiving, by one of the first controller or the second controller, a signal to stop the ground cutting implement; and
deactivating, by one of the first controller or the second controller, the fluid regulation valve and communicating the second instruction to the other of the first controller or the second controller to deactivate the flow control valve.

3. The method of claim 1, wherein the flow control valve is fluidly coupled in series with the fluid regulation valve and is positioned upstream to the fluid regulation valve with respect to a direction of the fluid flow to actuate the ground cutting implement.

4. The method of claim 1, wherein the one or more primary parameters include a current supplied to the fluid regulation valve for the activation of the fluid regulation valve.

5. The method of claim 1, wherein the one or more secondary parameters include a current supplied to the flow control valve for the activation of the flow control valve.

6. The method of claim 1 further comprising:
determining, by one of the first controller or the second controller, one or more additional parameters associated with a communication between the first controller and the second controller.

7. The method of claim 6 further comprising:
deactivating, by one of the first controller or the second controller, the fluid regulation valve and communicating the second instruction to the other of the first controller or the second controller to deactivate the flow control valve if any of the one or more additional parameters violate any corresponding parameter threshold conditions.

8. A machine, comprising:
a ground cutting implement;
a fluid regulation valve configured to be activated to regulate a fluid pressure to actuate the ground cutting implement and be deactivated to inhibit the fluid pressure to stop the ground cutting implement;
a flow control valve configured to be activated to allow passage of a fluid flow and be deactivated to disallow passage of the fluid flow;
a first controller and a second controller, one of the first controller or the second controller configured to:
receive an input to actuate the ground cutting implement;
determine one or more primary parameters associated with an activation of the fluid regulation valve in response to the input;
receive data corresponding to one or more secondary parameters associated with an activation of the flow control valve from the other of the first controller or the second controller;
activate the fluid regulation valve and communicate a first instruction to the other of the first controller or the second controller to activate the flow control valve if each of the one or more primary parameters and the one or more secondary parameters meet corresponding parameter threshold conditions; and
deactivate the fluid regulation valve and communicate a second instruction to the other of the first controller or the second controller to deactivate the flow control valve if any of the one or more primary parameters or the one or more secondary parameters violate any corresponding parameter threshold conditions.

9. The machine of claim 8, wherein the flow control valve is fluidly coupled in series with the fluid regulation valve and is positioned upstream to the fluid regulation valve with respect to a direction of the fluid flow to actuate the ground cutting implement.

10. The machine of claim 8, wherein the one or more primary parameters include a current supplied to the fluid regulation valve for the activation of the fluid regulation valve.

11. The machine of claim 8, wherein the one or more secondary parameters include a current supplied to the flow control valve for the activation of the flow control valve.

12. The machine of claim 8, wherein one of the first controller or the second controller is configured to:
receive a signal to stop the ground cutting implement; and
deactivate the fluid regulation valve and communicate the second instruction to the other of the first controller or the second controller to deactivate the flow control valve.

13. The machine of claim 8, wherein one of the first controller or the second controller is configured to determine one or more additional parameters associated with a communication between the first controller and the second controller.

14. The machine of claim 13, wherein one of the first controller or the second controller is configured to:
deactivate the fluid regulation valve and communicate the second instruction to the other of the first controller or the second controller to deactivate the flow control valve if any of the one or more additional parameters violate any corresponding parameter threshold conditions.

15. A system for controlling a ground cutting implement of a machine, the system comprising:
a fluid regulation valve configured to be activated to regulate a fluid pressure to actuate the ground cutting implement and be deactivated to inhibit the fluid pressure to stop the ground cutting implement;
a flow control valve configured to be activated to allow passage of a fluid flow and be deactivated to disallow passage of the fluid flow;
a first controller and a second controller, one of the first controller or the second controller configured to:
receive an input to actuate the ground cutting implement;
determine one or more primary parameters associated with an activation of the fluid regulation valve in response to the input;
receive data corresponding to one or more secondary parameters associated with an activation of the flow control valve from the other of the first controller or the second controller;
activate the fluid regulation valve and communicate a first instruction to the other of the first controller or the second controller to activate the flow control valve if each of the one or more primary parameters and the one or more secondary parameters meet corresponding parameter threshold conditions; and
deactivate the fluid regulation valve and communicate a second instruction to the other of the first controller or the second controller to deactivate the flow control valve if any of the one or more primary parameters or the one or more secondary parameters violate any corresponding parameter threshold conditions.

16. The system of claim 15, wherein the flow control valve is fluidly coupled in series with the fluid regulation valve and is positioned upstream to the fluid regulation valve with respect to a direction of the fluid flow to actuate the ground cutting implement.

17. The system of claim 15, wherein the one or more primary parameters include a current supplied to the fluid regulation valve for the activation of the fluid regulation valve.

18. The system of claim 15, wherein the one or more secondary parameters include a current supplied to the flow control valve for the activation of the flow control valve.

19. The system of claim 15, wherein one of the first controller or the second controller is configured to determine one or more additional parameters associated with a communication between the first controller and the second controller.

20. The system of claim 19, wherein one of the first controller or the second controller is configured to:
deactivate the fluid regulation valve and communicate the second instruction to the other of the first controller or the second controller to deactivate the flow control valve if any of the one or more additional parameters violate any corresponding parameter threshold conditions.
